(19) United States
(12) Patent Application Publication
(10) Pub. No.: US 2009/0313195 A1
(43) Pub. Date: Dec. 17, 2009

(54) Artificial neural network architecture

(75) Inventors: Liam MCDAID, Inch Island (IE); James HARKIN, Carndonagh (IE)

Correspondence Address: THE NATH LAW GROUP, 112 South West Street, Alexandria, VA, 22314, US

(73) Assignee: UNIVERSITY OF ULSTER, Coleraine (GB)

(21) Appl. No.: 12/453,218

(22) Filed: May 1, 2009

(30) Foreign Application Priority Data
Jun. 17, 2008 (GB) 0811057.9

(51) Int. Cl. G06E 1/00

(52) U.S. Cl. 706/26

(57) ABSTRACT

An artificial neural network apparatus comprising an array of neural units, each comprising a router, at least one neuron device and at least one synapse unit. The routers of respective neural units communicate with one another using data packets. The synapse units receive and create analogue signals, the routers converting these signals from or into packet form for communication between neural units. The use of routers in this way simplifies the required interconnectivity between neural units in the array and so facilitates the creation of large artificial neural networks.

### FIELD OF THE INVENTION

The present invention relates to artificial neural network architectures, especially for the implementation of spiking neural networks.

### BACKGROUND TO THE INVENTION

It is widely accepted that the basic processing units in the human brain are neurons that are interconnected in a complex pattern. The current understanding of real biological neurons is that they communicate through pulses and use the timing of the pulses to transmit information and perform computations. Spiking neural networks (SNNs) emulate more closely real biological neurons of the brain and have therefore the potential to be computationally more powerful than traditional artificial neural network models.

Known topologies that have been employed to model biological SNNs have proven difficult to emulate and accelerate in hardware, even for moderately complex networks. The ability to reconfigure and interconnect FPGA (Field Programmable Gate Array) logic blocks has attracted researchers to explore the mapping of SNNs to FPGAs. Efficient, low area/power implementations of synaptic junctions and neuron interconnects are key to scalable SNN hardware implementations. Existing FPGAs limit the synaptic density achievable as they map biological synaptic computations onto arrays of digital logic blocks, which are not optimised in area or power consumption for scalability. Additionally, current FPGA routing structures cannot accommodate the high levels of neuron inter-connectivity inherent in complex SNNs. The Manhattan-style mesh routing schemes of FPGAs typically exhibit switching requirements which grow non-linearly with the mesh sizes. A similar interconnect problem exists in System-on-Chip (SoC) design where interconnect scalability and high degrees of connectivity are paramount.

It would be desirable to mitigate these problems.

### SUMMARY OF THE INVENTION

A first aspect of the invention provides an apparatus for implementing an artificial neural network, especially a spiking neural network (SNN), the apparatus comprising an array of neural units, each unit comprising a router, at least one neuron device and at least one synapse cell, wherein the respective router of each neural unit is arranged to communicate with the router of one or more other neural units in the array using data packets. The router may for example comprise a packet switched router, or a circuit switched router.

The neuron device may take any suitable form and is arranged to exhibit neuron-like behaviour in accordance with a desired neuron model. Typically, this involves receiving at least one input (but typically a plurality of inputs) and generating an output in accordance with the neuron model. In preferred embodiments, the model is that of a spiking neuron in which an output is generated whenever the level of said at least one input exceeds a threshold. Typically, there are a plurality of inputs and these are summed, or otherwise combined, the neuron device generating an output if the cumulative level of the inputs exceeds the threshold. The output of the neuron device is preferably in the form of a spike, or pulse, signal.

The synapse cell may take any suitable form and is arranged to exhibit synapse-like behaviour in accordance with a desired synapse model. Typically, this involves receiving an input and generating a corresponding weighted output. In preferred embodiments, the input comprises a spike, or pulse, signal, and the output comprises a weighted spike, or pulse, signal. The weight applied by the synapse cell is preferably adjustable and to the end, the cell may include one or more weight inputs.

In the preferred embodiment, each neural unit is arranged such that at least one, but preferably a plurality of, synapse cells provide their outputs to a neuron device, the neuron device being arranged to provide its output to the router. The router may then create a data packet corresponding to the neuron device output and forward the data packet to one or more other neural units in the array depending on the topology of the neural network being implemented. When the router receives a data packet from another router that is destined for itself, the router is arranged to generate a corresponding input for the, or each, appropriate synapse cell in its neural unit. Typically, where the received data packet represents a spike event from another neural unit, a corresponding input signal is generated for only one of the synapse cells.

The data packets preferably include a destination address identifying the neural unit (or neuron device, especially in cases where a neural tile may have more than one neuron device) to which it is to be sent. Typically, each data packet representing a spike event from a neuron device is destined for a plurality of other neural units (as determined by the desired neural network topology). In this case the router may generate a respective data packet for each destination. The data packets may also include a source address identifying the neuron device, or neural tile (as most appropriate), from which the data packet emanated. The data packets may include a payload representing the spike event, or other data. In the case of spike events, the payload may comprise an indication of whether or not a spike is present, or may comprise data defining one or more characteristics of the spike, e.g. magnitude. Alternatively, the data packet itself may be used as a direct representation of a spike event.

In preferred embodiments, each neural unit is provided with a respective communication line to each other neural unit with which it is in direct communication. This allows the respective routers to communicate with one another. Conveniently, each neural unit is connected to each of its adjacent, or neighbouring, units in the array. In the case of a 2-dimensional rectangular array, each neural unit may have four communication lines to respective neighbouring units. Neural units at the edges of the array may be in communication with one or more output devices.

Each router preferably includes, or has access to, a respective address, or routing, table (or other means for determining how to route data packets in accordance with their destination). When a data packet is received by a router, the router upon determining that the packet is not destined for itself, may refer to its address table and, using the destination address in the data packet, determine how to route the data packet in order that it may reach its destination neural unit.

Conveniently, this involves determining from which of its communication lines to transmit the data packet. When the router creates a data packet in response to receiving a spike event from within its neural unit, it may refer to the address table (or another address table) to determine how many instances of the data packet are to be transmitted and from which communication lines.

Advantageously, the routers are arranged to transmit data packets to other routers using time multiplexing.

Preferably, the apparatus is a mixed signal apparatus, employing both analogue and digital signals. In preferred embodiments, the synapse cell, and preferably also the neuron device, comprise analogue devices and as such are arranged to receive and produce analogue signals. In contrast, communication between neural units is effected using packets of digital data. The neural units therefore include means for creating analogue signals from digital data and vice versa. In particular, each neural unit preferably includes at least one spike generator arranged to generate an analogue spike signal for input to one or more synapse cell. The conversion of the analogue output of the neuron device may effectively be achieved by the creation of a data packet by the router in response to detecting the neuron output.

Advantageously, each synapse cell comprises a plurality of synapse devices, each synapse device having a weight input that is selectably connectable to a source for providing a weight signal. Preferably, a plurality of weight signal sources are provided, respective weight inputs being connected to one or other of the sources. The weight signal sources conveniently comprise voltage lines, or rails, that are accessible to the synapse cell. Typically, each voltage line carries a different respective voltage. The weight inputs are preferably connectable to the respective weight source by means of a respective switch. Advantageously, each switch comprises a floating gate, or other suitable means for storing a voltage.

A second aspect of the invention provides a synapse cell comprising a plurality of synapse devices, each synapse device having a weight input that is selectably connectable to a source for providing a weight signal. Preferably, a plurality of weight signal sources are provided, respective weight inputs being connected to one or other of the sources. The weight signal sources conveniently comprise voltage lines, or rails, that are accessible to the synapse cell. Typically, each voltage line carries a different respective voltage. The weight inputs are preferably connectable to the respective weight source by means of a respective switch.

In arriving at the present invention, it is recognised that networking concepts can be used to address the interconnectivity problem using network-on-chip (NoC) approaches which time-multiplex communication channels. The NoC approach employs concepts from traditional computer networking to realise a similar communicating hardware structure. The key benefit from NoCs is scalable connectivity; higher levels of connectivity can be provided without incurring a large interconnect to device area ratio.

Preferred embodiments of the invention comprise a hardware platform for the realisation of SNNs. The preferred platform uses a NoC-based neural tile architecture and programmable neuron cell which address the interconnect and bio-computational resources challenges. The architecture supports the routing, biological computation and configuration of SNN topologies on hardware offering scalable SNNs with a synaptic density significantly in excess of what is currently achievable in hardware. In addition, the preferred architecture provides a new information processing paradigm which inherently has the ability to accommodate faults via its neural-based structures.

Preferred embodiments comprise a custom field programmable neural network architecture that merges the programmability features of FPGAs and the scalable interconnectivity of NoCs with low-area/power spiking neuron cells that have an associated training capability. The architecture supports the programmability of SNN topologies on hardware, providing an architecture which will enable the accelerated prototyping and hardware-in-loop training of SNNs.

By exploiting the relatively low frequency of biological spike trains, embodiments of the invention can use a regular and scalable NoC structure. The preferred time-multiplexing of spike data along router connections between layers of the neural network enables large parallel networks and high levels of routability, without the need for an overwhelmingly large number of connections. The preferred method of connecting neural tiles enables various SNN topologies to be realised. For example, multi-layered feed-forward and recurrent networks can be implemented.

Further advantageous aspects of the invention will become apparent to those ordinarily skilled in the art upon review of the following description of a specific embodiment and with reference to the accompanying drawings.

### BRIEF DESCRIPTION OF THE DRAWINGS

An embodiment of the invention is now described by way of example and with reference to the accompanying drawings in which:

FIG. 1 shows an example of a 2-layer spiking neural network;

FIG. 2 shows the synapse inputs to one of the layer 2 neurons from each of the layer 1 neurons in the network of FIG. 1;

FIG. 3 shows a representation of a neuron to neuron structure with synaptic junction;

FIG. 4 is a schematic diagram of a neural network architecture embodying one aspect of the present invention;

FIG. 5 is a schematic diagram of a neural unit forming part of the architecture of FIG. 4;

FIG. 6 is a schematic diagram showing three interconnected neural units;

FIG. 7 is a schematic diagram illustrating a preferred embodiment of the neural unit of FIG. 5;

FIG. 8 is a schematic diagram of a preferred embodiment of a synapse cell forming part of the neural unit of FIG. 5; and

FIG. 9 is a schematic diagram of a router suitable for use in the neural unit of FIG. 5.

### DETAILED DESCRIPTION OF THE DRAWINGS

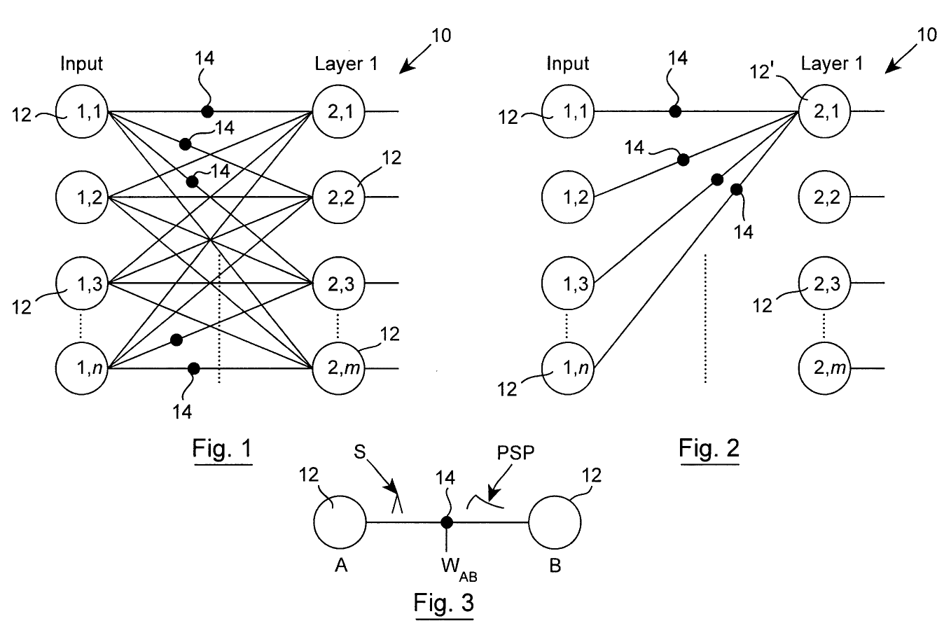

An example of a 2-layer feed-forward neural network is shown in FIG. 1, generally indicated as 10, and may for example be a spiking neural network (SNN). The network 10 comprises a plurality of neurons 12, each neuron 12 in one layer, in this case the input layer (on the left hand side of FIG. 1), is connected to every neuron 12 in the next layer, layer 1, via a respective synapse 14 and so on: the network 10 could have many layers. For clarity only a few synapses 14 are shown in FIG. 1. FIG. 2 illustrates using one neuron 12′ of the network 10, that for every neuron 12 there may be many synapses 14. Each synapse 14 forms a connecting node in a pathway between neurons 12, as shown in FIG. 1. It will be understood that FIGS. 1 and 2 are provided by way of illustration only and that the invention is not limited to feed-forward neural networks or 2-layer neural networks.

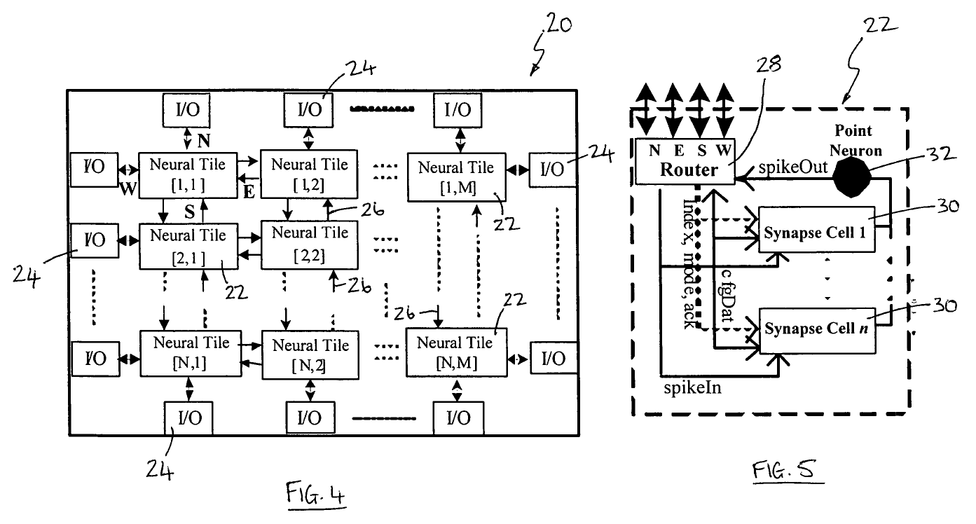

With reference to FIG. 3, an artificial model for a biological synapse is described. It is noted that biological synapses are known to exhibit extremely complex statistical behaviour and usually only first order models are considered. FIG. 2 shows a fragment of a neural network consisting of two point neurons (A and B) with an intermediate synapse, or synaptic junction 14.

Neuron A outputs a pulse signal in the form of a spike S, which forms the input to the synaptic junction 14. At the junction 14 the spike S is transmitted to the output neuron B, its magnitude having been weighted according to a weight value W_{AB}. The output of the synapse, known as the Post Synaptic Potential (PSP), typically resembles a transient function where the rise time constant and fall time constant are different from each other. For convenience, the output of a synapse can be represented as another spike whose magnitude is modulated by a weight W_{AB} provided at a weight input.

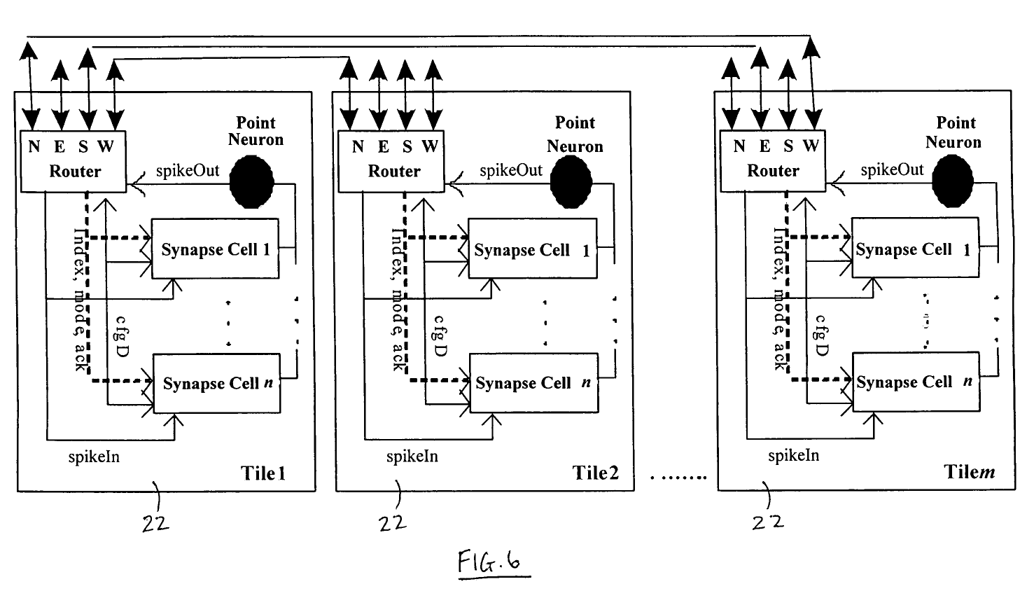

Referring now to FIG. 4 of the drawings, a preferred embodiment of a neural network apparatus, or architecture, embodying one aspect of the invention is indicated as 20. By way of example, the architecture 20 comprises a 2-dimensional array, preferably a regular array, of interconnected neural units 22 (referred to hereinafter as tiles 22), surrounded by a plurality of I/O blocks 24. Preferably, a respective I/O block 24 is provided at each end of each row and column of the array. The I/O blocks 24 may take any suitable form that allows the array 20 to interface with external devices (not shown). In the preferred embodiment, the I/O blocks 24 have a packet routing capability and may also include means for incorporating data into, and removing data from, data packets.

In the illustrated example, each neural tile 22 is connected to, or capable of communication with, each adjacent tile 22, and/or I/O block 24 as applicable, in its row and column. For the 2-dimensional array, each neural tile 22 is capable of communication with any one of four adjacent tiles 22 and/or I/O blocks 24 by a respective connection line 26 designated for convenience herein as North (N), East (E), South (S) and West (W), thereby forming a nearest neighbour connect scheme. It will be understood that the invention is not limited to 2-dimensional arrays of neural tiles. For example, 1-dimensional or 3-dimensional arrays of tiles may alternatively be provided. Also, the invention is not limited to the four-way interconnection between tiles. In general, each tile 22 may be arranged for communication with one or more other tiles 22.

Each neural tile 22 is configured to realise neuron-like functionality in order to collectively implement a neural network, especially an SNN. In an SNN, each neuron is arranged to fire, i.e. generate an output signal, whenever a parameter of the neuron, commonly known as a membrane potential, exceeds a threshold value. The, or each, synaptic input signal received by the neuron contributes cumulatively to the membrane potential. An SNN can be realised on the architecture 20 by suitable configuration of the functionality and interconnectivity of the tiles 22. Typically, signals sent from one neuron to another take the form of a train of pulses, commonly referred to as spikes. It is preferred therefore that architectures embodying the invention are adapted to produce and to process inter-neuron signals in the form of a train of spikes or other pulses.

By way of example, consider the interconnectivity requirements of the feed-forward (FF), 2-layer n×m SNN network 10, where each neuron 12 in the input layer is connected to m neurons in layer 1. When a neuron 12 in the input layer fires (i.e. generates an output signal typically in the form of a spike or pulse), its pulse output signal is propagated to the target neurons in layer 1 via dedicated individual synaptic lines 14. Using a network-on-chip (NoC) strategy, the same pattern of connectivity between neuron layers can be achieved through time-multiplexing of the communication channels 26 between the tiles 22.

To this end, each neural tile 22 includes a router 28, preferably a NoC router, arranged to send data to and receive data from, the, or each, other tile 22 (or I/O block 24) with which it is capable of communicating. Advantageously, data is transferred between tiles 22 in data packets, each data packet containing digital data relating to the inter-neuron signals. Each data packet may comprise payload data representing the output signal of a neuron, and header data comprising routing and/or management information, for example, identifying the destination neuron (or more particularly the destination neural tile 22) for the data packet. The routers may be configured to implement any suitable routing protocol(s). This significantly reduces interconnect density since the architecture 20 may comprise a relatively low number of fixed, regular-layout communication lines and a network of NoC routers.

Runtime and configuration data is propagated from source to destination, e.g. between neural tiles 22 and/or to or from external sources via the I/O blocks 24, preferably via time-multiplexing, using the NoC routing lines 26. For example, during runtime, spike events emanating from neural tiles 22 representing the input layer are forwarded to the associated neural tiles 22 representing layer 1 via one or more router transmission steps.

Typically, the router 28 has to send a data packet representing a spike event to a number of other neural tiles 22 that exceeds the number of network connections 26 (four in the present example: N, E, S, W) available to it. Preferably, therefore, the router 28 employs time multiplexing in respect of each of its network connections 26 when transmitting data packets. In the present example, each spike event is represented by a single data packet that is capable of being transmitted in a single time slot. Alternatively, each spike event may be represented by more than one data packet, each packet being sent in a respective time slot. Alternatively still, each data packet (which may represent all or part of a spike event) may be sent over a plurality of time slots, and may be interleaved with other data packets.

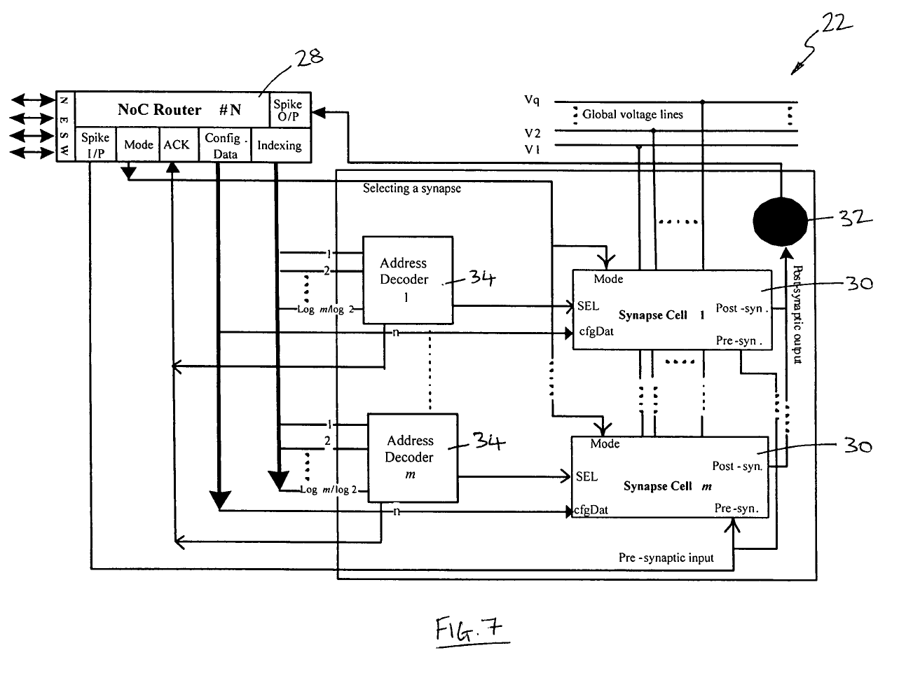

Referring to FIG. 5, in the preferred embodiment, each neural tile 22 comprises a router 28, at least one but typically a plurality of synapse devices 30 (hereinafter referred to as synapse cells 30), and at least one neuron device 32. FIG. 6 illustrates how the n×m neural network 10 (i.e. having n neurons in one layer and m neurons in the next layer) can be realised using the neural tiles 22. It will be seen that m neural tiles 22 are provided, each one corresponding to a respective one of the m post-synaptic neurons 12 of layer 1. A feed-forward (FF) network with 10³ neurons per layer would require 10³ neural tiles 22 each containing 10³ synapses. It is noted that FIG. 2 highlights which synapses 14 are connected to neuron (2, 1), and FIG. 6 illustrates how the synapse functionality is mapped to the first neural tile (Tile1). The mapping process is repeated for neurons (2, 2) through to (2, m), where all n synapses for each neuron are allocated to tiles 1 through to m, respectively. The inter-tile connections shown in FIG. 5 are given by way of example only.

In preferred embodiments, the router 28 of a respective tile 22 is used to communicate spike events generated by the respective neuron device 32 of the tile 22 to at least one, but typically a plurality of, synapse cells 30 located in one or more other neural tiles 22. In addition, each router 28 communicates spike events received by it from other neural tiles to the, or each, synapse cell 30 of its own neural tile 22, as applicable. The routers 28 output data packets when a spike-event occurs within the respective tile 22, i.e. is generated by the respective neuron device 32. The arrangement enables a reduced number of connections; for example, an SNN interconnect density of 10⁶ (n×m) can be implemented using 4×10³ (4×m connections), the factor 4 being specific to the example where there are 4 inter-tile connections (N, E, S and W). The n individual synapse cells 30 in a neural tile 22 may, in combination with the respective neuron device 32 (which may be referred to as a point neuron) may be referred to as a neuron cell. In practice, the neuron device 32 and the, or each, associated synapse cell 30 may be implemented as a single unit, i.e. neuron cell.

Advantageously, the operation of the synapse cell 30 is analogue in nature, i.e. it process, in an analogue manner, an analogue input signal to produce an analogue output signal. This helps the cell 30 to recreate efficiently the pertinent biological features of real synapses, for example as described with reference to FIG. 3, and preferably features such as long and short term plasticity. Alternatively, the synapse cells may be digital in nature. In preferred embodiments, however, the synapse cell 30 comprises one or more analogue synapse devices. There are many known examples of analogue electronic synapse devices that are suitable for use in the cell 30. For example, International PCT patent application WO2006/103109, which is hereby incorporated herein by way of reference, discloses an analogue electronic synapse device that is suitable for implementing the synapse cell 30 and is capable of mimicking the synapse behaviour described herein with reference to FIG. 3. It is preferred that the synapse device used in the cell 30 is capable of processing an input signal comprising a train of spikes, or other pulses.

The output responses from each synapse cell 30 are provided to the respective neuron device 32. In the preferred embodiment, the neuron device 32 comprises a threshold device (not illustrated) that generates an output signal whenever an input exceeds a threshold level. The input to the threshold device is typically a summation of the output responses of each synapse cell 30 connected to the neuron device 32. To this end, the neuron device 32 may comprise any suitable summation circuit (not shown). More conveniently, however, since the output signals from the synapse cells 30 are, in the preferred embodiments, analogue, they can be suitably combined by connecting together the outputs of the cells 30 and providing the combined output to the neuron 32. Electronic devices for implementing neuron functionality are known and any suitable such device may be used as the neuron device 32. By way of example, the neuron device 32 may comprise a comparator circuit designed to produce a spike output in response to an input threshold being exceeded.

The inputs, and in particular the spike inputs received from other neurons, are supplied to the synapse cells 30 via the respective router 28. The output from the neuron device 32 is transmitted from the respective tile 22 via the respective router 28. In use, data representing spike events of a spike train are received by the router 28 as data packets from other routers 28, where each spike-event data packet includes, for example, a source address (indicating the neural tile 22 in which the spike event originated) and a destination address (of destination neural tile 22 and synapse). In cases where a spike event may be represented as being either present or not present, the data packet itself may represent the spike event (e.g. the arrival of a data packet at a router is synonymous with the arrival of a spike). In such cases, there is no need for the data packet to include payload data representing the spike. Alternatively, the data packet may include payload data representing the spike (or more than one spike) since this allows a more sophisticated representation of the spike to be provided if required. In the present example, it is assumed that each spike event is represented by a single respective data packet. Alternatively, a signal data packet may represent more than one spike event. Alternatively still, each spike event may be represented by more than one data packet (e.g. where a spike event is represented by time-multiplexed interleaved data packets).

Referring now to FIG. 7, a preferred embodiment of the neural tile 22 is described. The router 28 is a packet-switched router implementing, for example, 12-bit communication paths, advantageously with buffer support. By way of example, a round-robin scheduling policy may be used by the routers 28 to transmit data packets around the network 20. The intra-tile communication lines/buses may include the following: Spike I/P and Spike O/P, Mode, ACK, Config Data and Indexing. Spike I/P carries a signal to initiate a spike on an individual synapse cell 30; Spike O/P receives spike events from the neuron device 32; Mode specifies the tile's mode of operation; the Indexing bus is used to address individual synapse cells 30 for receiving spike events or configuration data; ACK acknowledges the correct synapse cell addressing; the Config Data bus is used to transmit configuration data to the cells 30. In the preferred embodiment, the cells 30 configure connections to a plurality, q, of global voltage lines, V, which are common to the tiles 22.

Each neural tile 22 has a unique address within the array, and the synaptic connectivity between respective tiles 22 is specified using, for example, an Address Table (AT), or other suitable look-up device, that may be provided within each router 28, or at least accessible by each router 28. The AT may be programmed during a configuration period to specify the desired connectivity between tiles 22 and so enables spike events to be routed. When a spike event (which in this example takes the form of an analogue spike generated by the neuron device 32) is detected by the router 28 at Spike O/P, the router 28 refers to the AT in order to identify which neural tile(s) 22 must receive notification of the spike event (according to the configuration of the neural network). In the preferred embodiment where each tile 22 includes a plurality of synapse cells 30, the AT also identifies which of the synapse cells 30 within the, or each, tile 22 is to receive the notification. The router 28 creates an appropriate data packet for the spike event and transmits it onto the tile network via the appropriate one or more of its network connections 26. Conveniently, in respect of each destination tile 22, the AT need only identify a respective adjacent tile 22, or “nearest neighbour”, of the source tile 22 to which the data packet must be sent. This tells the router 28 from which of its network connections 26 to send the packet. Subsequently, when the “nearest neighbour” tile 22 receives the data packet, it checks whether or not it is destined for itself and, if not, consults its AT to determine in which direction to send the packet based on the destination address of the packet. In this way, the data packet is transmitted between tiles 22 from router to router until it is received by its destination tile 22. In the present example, data packets can be propagated by the router 28 in any direction (N, S, E or W) to neighbouring tiles 22.

Preferably, the neural tile 22 is operable in one of two modes: runtime or configuration. In runtime mode, the tile 22 routes spike events and computes the programmed SNN functionality. In configuration mode, the tile 22 is configurable to realise desired synapse models and the desired neural network topology. Configuration data may be delivered to the tile 22 in the form of data packets where each packet is addressed to a particular neural tile 22 and contains information on the configuration of, for example, the router's AT, the selection of cell synapse weights via the programmable voltage lines, V₁ to V_{q}, and any other relevant neural tile parameters. This strategy fully exploits the flexibility of the NoC structure by additionally using it to select and distribute configuration data to the tiles 22. It is envisaged that the configuration mechanism may be used to partially support the repair implementation of a tile's neural structure in the event of faults. Dedicated mode data packets may be transmitted around the array 20 to initiate the respective modes. Alternative, mode data may be transmitted in the other data packets carrying spike event data and/or configuration data.

During either runtime or configuration mode, the router 28 sends to the synapse cells 30 an indexing signal that determines with which synapse cell 30 in the tile 22 the router 28 communicates in response to receiving a particular data packet. By way of example, each synapse cell 30 may be associated with a respective address decoder 34, which enables its respective synapse cell 30 by means of a select signal (SEL) to receive data from the router 28 whenever an appropriate indexing signal is present. In the present example, when a given synapse cell 30 is enabled by its respective address decoder 34, it is able to receive, from the router 28 (via Spike I/P or ConfigData respectively), data representing a spike event received by the tile 22, or configuration data received by the tile 22, depending on the mode of operation. Conveniently, the data for creating the necessary indexing signal is contained within the received data packet. The provision of the indexing feature allows a common Spike I/P communication line and a common ConfigData communication line (typically a communication bus) to be provided between the router and each cell 30. Preferably, the address decoders 34 are arranged to send an acknowledgement signal ACK to the router 28 when they detect from the indexing signal that their respective cell 30 has been selected.

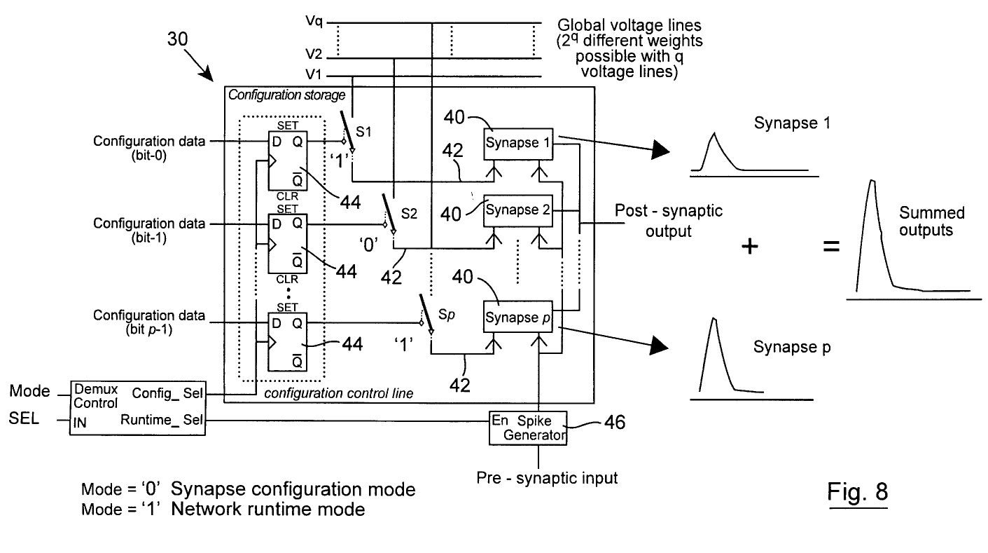

In the illustrated embodiment, the Spike I/P data is digital, e.g. a digital indication of a spike event, but the synapse cell 30 operates on analogue spikes to create its response. Hence, the tile 22 is provided with a spike generating circuit (not shown in FIG. 7) for converting the digital Spike I/P signal into an appropriate analogue spike signal. The spike generating circuit may take any convenient form. In the illustrated embodiment, each synapse cell 30 is provided with a respective spike generator 46 for this purpose (see FIG. 8).

Referring now to FIG. 8, a preferred embodiment of the synapse cell 30 is described incorporating a preferred weight distribution and storage architecture. In order to implement the adjustable weight for the synapse cell 30, each cell 30 advantageously comprises a plurality, p, of analogue electronic synapse devices 40, each exhibiting the desired synaptic behaviour described above. Each synapse device 40 has a weight input 42 that is selectably connectable to one of a plurality, q, of voltage supply lines V by means of a respective switch S₁-Sₚ. This arrangement allows one or more of the synapse devices 40, in any combination, to be hardwired to its respective voltage line V₁-V_{q} depending on the setting of the switches S₁-Sₚ, the setting of the switches conveniently being determined by the configuration data during the configuration mode described above. For example, the configuration data may include a respective data bit for each device 40, the value of which determines the setting of the respective switch S₁-Sₚ. A respective latch 44 may be provided to operate each switch S₁-Sₚ depending on the respective bit of the configuration data signal and under the control of a clock signal Config_Sel.

The respective outputs of the synapse devices 40 are summed, e.g. connected together, to create a cumulative output signal providing the output signal of the cell 30. When a respective switch is open, the corresponding synapse device 40 is not connected to a voltage line and so does not contribute to the summed output signal. This arrangement has the effect of providing a relatively large range of programmable weight voltage levels for the cell 30. Hence, depending on the actual respective voltage values, the V₁-V_{q} rails provide a range of supply weights (voltages), selected using digitally controlled analogue switches (S₁-Sₚ). FIG. 8 illustrates by way of example how the current outputs of the synapses 40 are summed when weight voltages V₁ and V_{q} are applied to synapse 1 and p. Table 1 illustrates an example synapse cell weight selection where q=p=6, V₁=0.08, V₂=0.16, V₃=0.32, V₄=0.64, V₅=1.28, V₆=2.56 volts. Varying the number of voltage rails (q) increases the weight range and varying the weight rail voltage values modifies the weight resolution. Selecting combinations of rail voltages using S₁-S₆ provides a range of possible synapse weights, as illustrated in Table 1. It is noted that where p is equal to or less than q, each synapse device 40 may be connectable to its own respective voltage line. Alternatively (and whether or not p equals or is less than q), more than one synapse device 40 may be connected to the same voltage rail.

TABLE 1

| | | | | | | Synapse | |
|---|---|---|---|---|---|---|---|
| | | | | | | cell | |
| S6 | S5 | S4 | S3 | S2 | S1 | weight | |
| 1 | 1 | 1 | 1 | 1 | 1 | 5.04 | V |
| . | . | . | . | . | . | . | |
| . | . | . | . | . | . | . | |
| . | . | . | . | . | . | . | |
| 1 | 0 | 0 | 0 | 0 | 0 | 2.56 | |
| 0 | 0 | 0 | 0 | 0 | 1 | 0.08 | V |
| 0 | 0 | 0 | 0 | 0 | 0 | 0 | V |

In alternative embodiments, it is preferable to provide a non-volatile memory capability for storing selected weight values. This may be achieved by replacing the latches and switches of FIG. 8 with standard flash memory techniques using floating gates. For example, each switch may comprise a floating gate connected to a suitable current driver. This approach to non-volatile weight storage only requires that the transistors associated with each floating gate operate in either a fully on or off mode (binary operation).

In keeping with biological plausibility, synapse weight updates for long term plasticity are preferably governed by a Hebbian-based rule. An off-line training procedure using this rule may be employed.

Typically, the communication of data packets between tiles 22 is performed in a synchronous manner, although asynchronous routing schemes may alternatively be used. However, in the preferred embodiment, the internal tile 22 operation (i.e. the communication between the router 28 and the synapse cells 30 and neuron device 32, and the operation of the synapse cells 30 and neuron device 32) is asynchronous. In use, respective data packets intended to trigger spike events at respective synapse cells 30 within a given tile 22 will arrive at the tile 22 at different times and so will be communicated to the respective synapse cell 30 at different times. However, this does not unduly affect the operation of the neuron device 32 since the operation of the synapse cell 30 in processing a spike event to create its output response is typically sufficiently slow that the time difference between arriving data packets does not significantly delay the outputs of the synapse cells 30. For example, time multiplexing of the data packets may be perform in the order of micro seconds while the synapse cells 30 may operate in the order of milliseconds. Should the time difference between data packets become problematic, a delay element (not shown) may be introduced to one or more synapse cell 30 to ensure that the synaptic outputs arrive at the neuron device 32 at the desired time.

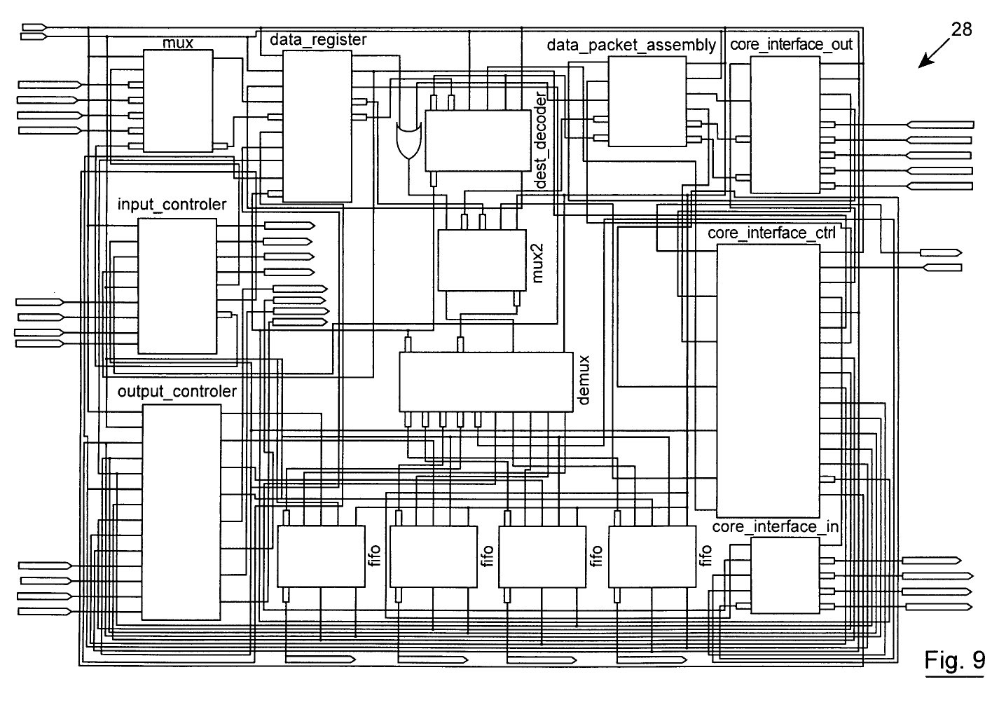

The router 28 may be implemented in any convenient manner to provide the functionality provided above. By way of example, FIG. 9 shows a schematic diagram of a suitable router. The router 28 is responsible for controlling the transmission and receipt of packet data from its neighbour routers, and also interfacing to the tile's neuron 32 and synapse cells 30. To this end, each router provides co-ordinate input and output (I/O) connections and control in each connection direction (N, E, S, W in the present example). The input and output controllers, input_controller and output_controller, provide, for example, simple handshaking for data I/O transmission between neural tiles and the buffering of incoming and outgoing packets in the data_register and FIFO (First-In First-Out). The data_register and FIFO (First-In First-Out) can also be considered as virtual channels. The mux and demux stages are used to switch or multiplex incoming and outgoing packets on the channels into the data_register and FIFO components.

In alternative embodiments, the addition of larger numbers of neurons and/or synapses within individual neural tiles reduces the number of routers required for the NN implementations. An additional benefit is the reduction in packet generation and receipt by each router, as a portion of neurons would generate and receive spike events locally within a tile. The maximum level of local neuron generation/receipt would be dependant on the configured SNN topology. Further optimisation of the tile architecture can be achieved by exploring the minimum number of synapses, p, per synapse cell. Reducing the number of synapses per cell can reduce the area requirements of the array 20.

In preferred embodiments, each tile includes at least one neuron device together with one or more pre-neuron synapse cells. Alternatively, a tile may include at least one neuron with one or more post neuron synapse cells, or a combination of at least one neuron with one or more post neuron synapse cells and one or more post neuron synapse cells.

Since the preferred NoC approach supports a regular layout of the tiles and neuron communication, the interconnectivity between network layers does not limit the network size that can be implemented.

In preferred embodiments, two levels of fault tolerance proposed; at the synapse level and at the tile level. The abstract basis of SNNs is the strengthening and weakening of synaptic weights, where training algorithms are used to derive appropriate weight values to reflect a mapping between the input and desired output data. Faults occurring in individual synapses can be tolerated by using such algorithms to appropriately re-train the network when the output deviates from the desired patterns. This process may be achieved via the strengthening and/or weakening of neighbouring synapse weights within the tile. At a more coarse level, complete tiles can be re-mapped or relocated to fault-free tiles, whereby the configurable data of a damaged tile is re-configured to a new tile with updated router address contents and synaptic weights. For example, each neural tile may retain a copy of the configuration data for each of its (four) co-ordinate neighbours. When a fault is detected in one of the neighbouring tiles, using any appropriate scheme, the centre tile may take control and relocate the configuration data of the faulty tile to a new available tile. An address update packet may be broadcast to all tiles informing of the new location of the repaired tile. This approaches aims to provide a more robust distributed repair mechanism as opposed to a centrally controlled strategy.

The invention is not limited to the embodiments described herein which may be modified or varied without departing from the scope of the invention.

1. An artificial neural network apparatus comprising an array of neural units, each neural unit comprising a router, at least one neuron device and at least one synapse unit, wherein the respective router of each neural unit is arranged to communicate with the respective router of one or more other neural units in the array using data packets.

2. An apparatus as claimed in claim 1, wherein each neuron device is arranged to generate, in response to receiving a respective synapse output signal from at least one synapse unit, a neuron output signal for communication to at least one other neuron device in at least one other neural unit, the arrangement being such that said neuron output signal is sent to said router and wherein, in response to receiving said neuron output signal, said router is arranged to create a corresponding data packet and to cause said corresponding data packet to be sent to said at least one other neural unit in the array.

3. An apparatus as claimed in claim 1, wherein each data packet represents an inter-neuron spike signal.

4. An apparatus as claimed in claim 1, wherein, in response to receiving a data packet from the respective router of another neural unit in said array, said router is arranged to determine if the received data packet is destined for its respective neural unit and, upon so determining, to generate a corresponding input signal for at least one of said at least one synapse units in its respective neural unit.

5. An apparatus as claimed in claim 4, wherein said corresponding input signal is generated for only one of said at least one synapse unit.

6. An apparatus as claimed in claim 1, wherein each data packet includes a respective destination address that determines to which said neural units it is to be sent.

7. An apparatus as claimed in claim 6, wherein, in respect of neural units that include more than one neuron device, said destination address determines to which neuron device the data packet is destined.

8. An apparatus as claimed in claim 6, wherein, in respect of neural units having a plurality of synapse units, said destination address determines to which synapse unit the data packet is destined.

9. An apparatus as claimed in claim 2, wherein, in the event that said neuron output signal is destined for more than one other neuron device in at least one other neural unit, the router is arranged to generate a respective data packet for each of said other neuron devices.

10. An apparatus as claimed in claim 1, wherein each data packet includes a source address identifying the neuron device from which the data packet emanated.

11. An apparatus as claimed in claim 1, wherein each data packet includes a payload comprising data representing an inter-neuron signal.

12. An apparatus as claimed in claim 11, wherein the payload comprises data defining one or more characteristics of the inter-neuron signal.

13. An apparatus as claimed in claim 1, wherein a respective communication line is provided between each neural unit and each other neural unit with which it is in direct communication.

14. An apparatus as claimed in claim 13, wherein a respective communication line is provided between each neural unit arid the, or each, of its adjacent neural units in the array.

15. An apparatus as claimed in claim 1, wherein a plurality of output units are provided around said array, each neural unit that is located peripherally in the array being in communication with at least one of said output units by means of a respective communication line.

16. An apparatus as claimed in claim 1, wherein each data packet includes a destination address and each router has access to at least one routing table comprising data determines to which other neural unit said data packets are to be sent from said router depending on said destination address.

17. An apparatus as claimed in claim 16, wherein, in respect of neural units that have a plurality of synapse units, said routing table data indicates to which synapse unit the packet is destined.

18. An apparatus as claimed in claim 16, wherein, in response to receiving a data packet from another neural unit, the router, upon determining that the received data packet is not destined for itself, is arranged to refer to said at least one routing table and, using the destination address in said received data packet, to determine to which other neural unit to send the received data packet.

19. An apparatus as claimed in 2, wherein each data packet includes a destination address and each router has access to at least one routing table comprising data indicating to which other neural unit said data packets are to be sent from said router depending on said destination address and wherein, when creating said corresponding data packet in response to receiving said neuron output signal, said router is arranged to refer to said at least one routing table to determine how many instances of the data packet are to be transmitted and to which respective other neural units said instances of the data packet are to be transmitted.

20. An apparatus as claimed in claim 1, wherein said router is arranged to transmit data packets to other routers using time multiplexing.

21. An apparatus as claimed in claim 2, wherein said router is a packet switched router or a circuit switched router.

22. An apparatus as claimed in claim 2, wherein said neuron device is arranged to generate said neuron output signal in accordance with a neuron model.

23. An apparatus as claimed in claim 22, wherein said model is a spiking neuron model whereby said neuron output is generated whenever the level of the, or each, received synapse output signal exceeds a threshold.

24. An apparatus as claimed in claim 23, wherein said neuron device receives a plurality of synapse unit outputs, the neuron device being arranged to generate said neuron output signal if the cumulative level of the received synapse unit outputs exceeds the threshold.

25. An apparatus as claimed in claim 1, wherein said synapse unit is arranged to receive an input signal and to generate a corresponding weighted output signal.

26. An apparatus as claimed in claim 25, wherein said synapse unit includes at least one weight input and is arranged to apply an adjustable weight to said input signal depending on a weight value received by said at least one weight input.

27. An apparatus as claimed in claim 25, wherein said input comprises a spike signal, and the output comprises a weighted spike signal.

28. An apparatus as claimed in claim 1, wherein at least one of the synapse unit and the neuron device comprise analogue devices arranged to receive and produce analogue signals.

29. An apparatus as claimed in claim 28, wherein said neural unit includes means for creating, in response to receiving a data packet from the respective router of another neural unit in said array that is destined for itself, a corresponding analogue input signal for at least one of said at least one synapse units in the neural unit.

30. An apparatus as claimed in claim 29, wherein each neural unit includes at least one spike generator arranged to generate an analogue spike signal for input to one or more synapse cell.

31. An apparatus as claimed in claim 1, wherein each synapse unit comprises a plurality of electronic synapse devices, each synapse device having a weight input that is selectably connectable to a source for providing a weight signal.

32. An apparatus as claimed in claim 1, wherein a plurality of weight signal sources are provided, respective weight inputs being connectable to one or other of the sources.

33. An apparatus as claimed in claim 32, wherein said weight signal sources comprise respective voltage sources that are accessible to the synapse unit.

34. An electronic synapse unit comprising a plurality of electronic synapse devices, each synapse device having a weight input that is selectably connectable to a source for providing a weight signal.
